(19) United States
(12) Patent Application Publication
(10) Pub. No.: US 2008/0204216 A1
(43) Pub. Date: Aug. 28, 2008

(54) TIRE INFORMATION DETECTING APPARATUS

(76) Inventor: Hideki Masudaya, Miyagi-ken (JP)

Correspondence Address: ACCENTURE CHICAGO 28164;BRINKS HOFER GILSON & LIONE, P O BOX 10395, CHICAGO, IL, 60610, US

(21) Appl. No.: 12/019,089

(22) Filed: Jan. 24, 2008

(30) Foreign Application Priority Data
Feb. 22, 2007 (JP) 2007-042612

(51) Int. Cl. B60C 23/00

(52) U.S. Cl. 340/447

(57) ABSTRACT

A tire information detecting apparatus comprises a transponder that is provided in a tire of a vehicle and a controller that is provided in a vehicle body. The transponder comprises an antenna; a modem (modulator/demodulator) that modulates or demodulates signals transmitted between the transponder and the controller; a resonator that resonates in response to a signal transmitted from the controller; a pressure sensor that detects the air pressure of the tire; and a switch that connects or disconnects the crystal resonator to or from the pressure sensor.

This application claims benefit of the Japanese Patent Application No. 2007-042612, filed on Feb. 22, 2007, the entire content of which is hereby incorporated by reference.

### FIELD

The present invention relates to a tire information detecting apparatus, and more particularly, to a tire information detecting apparatus that detects tire information including the air pressure of tires used for vehicles.

### BACKGROUND

A wireless communication apparatus has been proposed in which measured values, such as the air pressure of tires used for vehicles, are wirelessly transmitted to a controller provided in a vehicle body and the controller alerts a driver on the basis of the measured values (for example, see U.S. Pat. No. 6,378,360). In such a wireless communication apparatus, the controller shown in FIG. 5 is provided in the vehicle body, and a measured value transmitter (transponder) shown in FIG. 6 is provided in each tire.

As shown in FIG. 5, the controller includes a carrier wave oscillator G1 that generates a carrier wave (f1) in a frequency band of about 2.4 GHz, a modulator MO1, and an oscillator G2 that generates an oscillation signal for modulation. The oscillator G2 outputs to the modulator MO1 an oscillation signal having a frequency (f2) that is close to the resonant frequency of a resonator of a transponder, which will be described below. The carrier wave output from the carrier wave oscillator G1 is amplitude-modulated by the oscillation signal output from the oscillator G2 into a 2.4 GHz high-frequency signal, and the amplitude-modulated high-frequency signal is amplified by an amplifier (not shown). Then, the amplified signal is radiated from an antenna A1 in the vicinity of the tire.

The controller includes a switch S1 that turns on or off an amplitude modulating operation of the modulator MO1, a receiver E1 that receives the high-frequency signal transmitted from the transponder and calculates a measured value (S1), such as the air pressure of the tire, and a timer T1 that controls the switching timing of the switch S1 and the state of the receiver E1. The amplitude modulation of the carrier wave is controlled by the timer T1. For example, the high-frequency signal whose amplitude is modulated is transmitted for a predetermined time, and the amplitude modulation stops at a time t1. Then, a carrier wave whose amplitude is not modulated is transmitted. The receiver E1 is activated at a time t2 that is about one millisecond or less after the time t1, and receives the high-frequency signal transmitted from the transponder through the antenna A4.

As shown in FIG. 6, the transponder includes a low pass filter L1/C1, a diode D1, serving as a modem (modulator/demodulator), a capacitive pressure sensor SC1 having capacitance that varies according to the air pressure of the tire, and a resonator including a crystal resonator Q1 that is excited in response to a frequency component included in the modulated signal transmitted from the controller. The low pass filter L1/C1 removes the 2.4 GHz carrier wave from the high-frequency signal transmitted from the controller, and the signal passing through the filter is demodulated by the diode D1. In this way, a signal having the same frequency as that of the oscillation signal of the oscillator G2 is extracted. Since the resonant frequency of the resonator is close to the frequency of the oscillation signal output from the oscillator G2, the resonator is excited by the signal. The excitation causes a resonant frequency signal to be generated. When the capacitance of the capacitive pressure sensor SC1 varies according to the air pressure of the tire, the resonant frequency of the resonator is also changed. Therefore, the resonant frequency signal is also affected by the variation in the air pressure of the tire.

As described above, the controller transmits the amplitude-modulated high-frequency signal, stops the amplitude modulation, and transmits the carrier wave whose amplitude is not modulated. The resonator continues to resonate for about one millisecond or more after the amplitude modulation stops. Therefore, the carrier wave transmitted from the controller whose amplitude is not modulated is amplitude-modulated by the diode D1 in response to the resonant frequency signal from the resonator, and the amplitude-modulated signal is radiated from an antenna A3. The receiver E1 receives the amplitude-modulated high-frequency signal through the antenna A4, and a demodulator (not shown) demodulates the received signal to extract the resonant frequency signal. In this way, it is possible to calculate a measured value (V1), such as the air pressure of the tire.

In the wireless communication apparatus disclosed in U.S. Pat. No. 6,378,360, the transponder is provided with a plurality of resonators and transmits signals for measured values, such as the temperature of tire, and the controller calculates the measured values.

However, in the wireless communication apparatus according to the related art in which the transponder is provided with a plurality of resonators to detect a plurality of measured values, such as the air pressure and temperature of the tire, since the resonators have different temperature characteristics or degradation characteristics with time, errors occur in the measured values, which makes it difficult to detect accurate measured values.

In particular, when the air pressure of the tire is measured, the resonant frequency of a resonator for measuring the air pressure is affected by both the air pressure and the temperature of the tire. Therefore, the air pressure of the tire is calculated as follows: the temperature of the tire is calculated from the resonant frequency of a resonator for measuring the temperature; and the temperature value is used to compensate for the influence of the temperature to calculate the air pressure of the tire. However, in this case, it is difficult to accurately correct the difference between the temperature characteristics of the resonators or the degradation characteristics thereof with time.

### SUMMARY

According to an aspect, a tire information detecting apparatus comprises a measured value transmitter that is provided in a tire of a vehicle, and a controller that is provided in a vehicle body and transmits/receives signals to/from the measured value transmitter. The measured value transmitter comprises an antenna, a modem (modulator/demodulator) that modulates or demodulates the signals transmitted between the measured value transmitter and the controller, a resonator that resonates in response to a signal transmitted from the controller, a pressure sensor that detects the air pressure of the tire, and a switch that connects or disconnects the resonator to or from the pressure sensor.

According to another aspect, a tire information detecting apparatus comprises a measured value transmitter that is provided in a tire of a vehicle, and a controller that is provided in a vehicle body and transmits/receives signals to/from the measured value transmitter. The measured value transmitter comprises a resonator that resonates in response to a signal transmitted from the controller, a pressure sensor that detects the air pressure of the tire, and a switch that connects or disconnects the resonator to or from the pressure sensor. The switch is turned on or off according to the rotation of the tire to connect or disconnect the resonator to or from the pressure sensor.

Accordingly yet another aspect, a tire information detecting apparatus comprises a measured value transmitting means that is provided in a tire of a vehicle, and a controlling means that is provided in a vehicle body and transmits/receives signals to/from the measured value transmitting means. The measured value transmitting means comprises a resonating means that resonates in response to a signal transmitted from the controlling means, a pressure sensing means that detects the air pressure of the tire, and a switching means that connects or disconnects the resonator to or from the pressure sensing means. The switching means is turned on or off according to the rotation of the tire to connect or disconnect the resonating means to or from the pressure sensing means.

### BRIEF DESCRIPTION OF THE DRAWINGS

FIG. 1 is a diagram illustrating an example of the circuit structure of a transponder of a tire information detecting apparatus according to an embodiment;

FIG. 2 is a diagram illustrating the structure of a ground detecting sensor for detecting the rotation of a tire in the tire information detecting apparatus according to the embodiment;

FIG. 3 is a diagram illustrating the structure of an inclination sensor for detecting the rotation of a tire in the tire information detecting apparatus according to the embodiment;

FIG. 4 is a graph illustrating the difference between a resonant frequency extracted from a signal transmitted from the transponder and the frequency of an oscillation signal from a controller;

FIG. 5 is a diagram schematically illustrating the circuit structure of a controller of a tire information detecting apparatus according to the related art; and

FIG. 6 is a diagram schematically illustrating the circuit structure of a transponder of the tire information detecting apparatus according to the related art.

### DETAILED DESCRIPTION

Hereinafter, an embodiment of the present disclosure will be described in detail with reference to the accompanying drawings. Similar to the tire information detecting apparatus (wireless transmission apparatus) according to the related art, a tire information detecting apparatus according to an embodiment of the present disclosure includes a controller that is provided in a vehicle body and a measured value transmitter (hereinafter, referred to as a transponder) provided in tires.

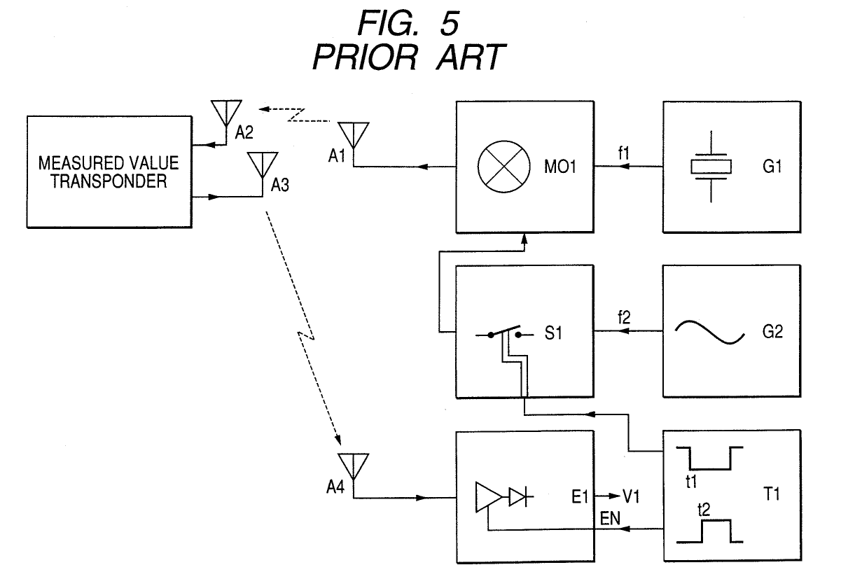

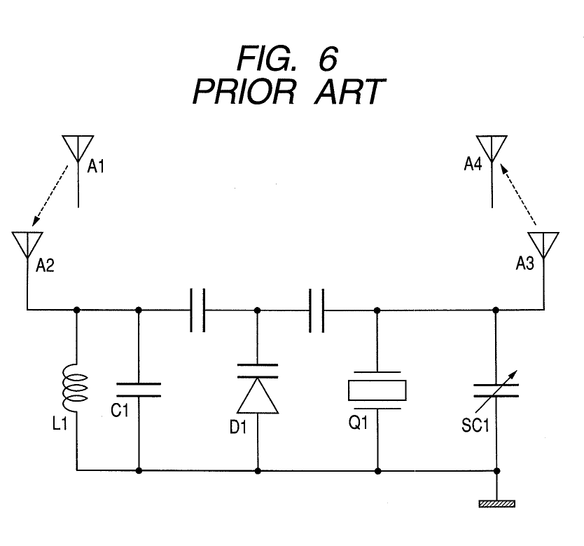

The tire information detecting apparatus according to this embodiment differs from the tire information detecting apparatus according to the related art in the structure of the transponder. The controller calculates measured values, such as the air pressure of tires, on the basis of signals transmitted from the transponder. Therefore, the tire information detecting apparatus according to this embodiment can detect measured values with high accuracy, as compared to the tire information detecting apparatus according to the related art. Next, the circuit structure of the transponder forming the tire information detecting apparatus according to this embodiment will be described in detail. In addition, it is assumed that the controller includes the same components as those shown in FIG. 5.

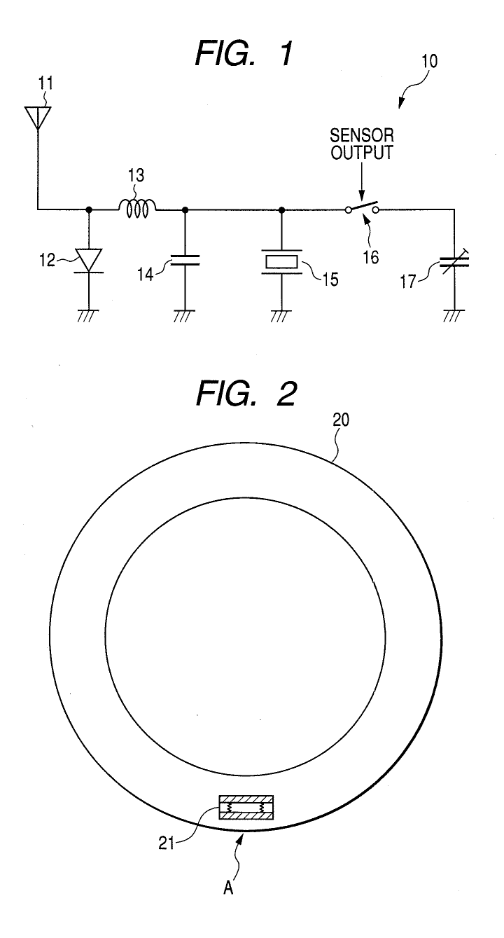

FIG. 1 is a diagram illustrating the circuit structure of the transponder forming the tire information detecting apparatus according to this embodiment.

As shown in FIG. 1, a transponder 10 according to this embodiment includes an antenna 11 for transmitting or receiving signals and a diode 12 connected to the antenna 11. The diode 12 has an anode connected to input/output terminals of the antenna 11 and a cathode connected to the ground. An inductor 13 has one end connected to the anode of the diode 12 and the other end connected to the ground through a capacitor 14. The inductor 13 and the capacitor 14 form a low pass filter. The low pass filter has high frequency characteristics capable of removing a carrier wave in a frequency band of about 2.4 GHz. The low pass filter and the diode 12 form a demodulator. The diode 12 functions as a modulator.

A crystal resonator 15 for measuring the temperature and air pressure of the tire is connected to one end of the inductor 13. The crystal resonator 15 has one electrode connected to the one end of the inductor 13 and the other electrode connected to the ground. The crystal resonator 15 serves as a resonator. A pressure sensor 17 is connected to the one electrode of the crystal resonator 15 through a switch 16. The switch 16 is turned on or off according to the rotation of the tire having the transponder 10 provided therein, which will be described in detail below. The pressure sensor 17 is composed of a variable capacitor whose capacitance varies according to the pressure detected. The pressure sensor 17 has one electrode connected to one end of the switch 16 and the other electrode connected to the ground.

In the transponder 10 according to this embodiment, the switch 16 is turned on or off according to the rotation of the tire to change the connection state of the pressure sensor 17 to the crystal resonator 15. Specifically, when the switch 16 is turned off, the pressure sensor 17 is disconnected from the crystal resonator 15, and the crystal resonator 15 resonates (only the crystal resonator 15 resonates). When the switch 16 is turned on, the crystal resonator 15 resonates while being connected to the pressure sensor 17.

In the former case, the resonant frequency of the crystal resonator 15 is affected by only the temperature of the tire. In the latter case, the resonant frequency of the crystal resonator 15 is affected by the air pressure of the tire as well as the temperature of the tire. In the tire information detecting apparatus according to this embodiment, the switch 16 is turned on or off according to the rotation of the tire to measure only the temperature of the tire or both the temperature and the air pressure of the tire.

In the tire information detecting apparatus according to this embodiment, the switch 16 is turned on or off according to the rotation of the tire, but the invention is not limited thereto. In this embodiment, any structure can be used as long as the switch 16 can be turned on or off according to the rotation of the tire.

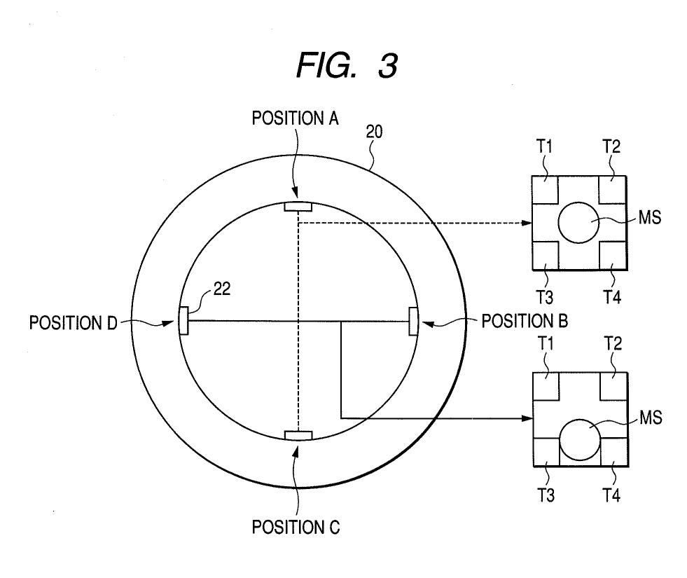

When the switch 16 is turned on or off according to the rotation of the tire, for example, it is considered that the switch is turned on or off according to whether the connection of a specific point of the tire in a circumferential direction thereof to the ground is detected, or according to the angle of the tire. FIG. 2 is a diagram illustrating the structure of a ground detecting sensor that detects the connection of a specific point of the tire in the circumferential direction to the ground and is turned on or off on the basis of the result of the detection. FIG. 3 is a diagram illustrating the structure of an inclination sensor that detects the angle of the tire and is turned on or off on the basis of the result of the detection.

In the structure that detects the connection of a specific point of the tire in the circumferential direction to the ground and turns on or off the switch 16 on the basis of the result of the detection, as shown in FIG. 2, a contact type switch 21 having two electrodes is provided in a tire 20 at a specific position in the circumferential direction, and a signal is output to the switch 16 when a ground detecting point A is grounded. Specifically, when the ground detecting point A is grounded, there is no gap between the two electrodes of the contact type switch 21, and the contact type switch 21 is turned on. Then, a signal is output from the contact type switch 21 to turn on or off the switch 16. In this case, when the tire makes one revolution, the signal is output once.

In the structure that detects the angle of the tire to turn on or off the switch 16 on the basis of the result of the detection, as shown in FIG. 3, an inclination sensor 22 having terminals T1 to T4 and a metal sphere MS is provided, and the inclination sensor 22 outputs a signal to switch 16 according to the connection state between the terminals and the metal sphere. For example, when the inclination sensor 22 is disposed downward at a position A of the tire 20, the metal sphere MS is arranged at the center of the inclination sensor at the position A and signals are output from the terminals T1 to T4. Meanwhile, when the inclination sensor rotates 90° from the position A in the clockwise direction to reach a position B, the metal sphere MS moves down to electrically connect the terminal T3 and the terminal T4, and signals are output from the terminals. Similarly, no signal is output at a position C, but signals are output from the inclination sensor at a position D. The switch 16 is turned on or off in response to the signals output from the inclination sensor. In this case, when the tire makes one revolution, the signals are output twice.

The controller according to this embodiment has the same operation as that according to the related art. That is, the controller determines whether to modulate the amplitude of signals on the basis of the on or off state of a switch S1, extracts a resonant frequency signal from a high-frequency signal transmitted from the transponder 10, and calculates measured values, such as the air pressure of the tire. As described above, when the switch 16 is turned on or off according to the rotation of the tire, the resonant frequency of the signal transmitted from the transponder 10 is changed, which makes it possible to measure both the temperature and the air pressure of the tire.

In the transponder 10 having the above-mentioned structure in which the switch 16 is turned on or off according to the rotation of the tire, when the tire rotates at a high speed, a resonant frequency corresponding to the on state of the switch 16 and a resonant frequency corresponding to the off state of the switch 16 are switched at a high speed. When the controller calculates the measured values of the tire on the basis of the resonant frequencies that are switched at a high speed, it is preferable that the controller calculate the measured values of the tire by statistically processing peak values of the resonant frequencies.

Next, the operation of the tire information detecting apparatus measuring the temperature and air pressure of the tire will be described below. In the following description, it is assumed that the ground detecting sensor shown in FIG. 2 is provided in the tire, an odd-numbered signal output from the contact type switch 21 turns on the switch 16, and an even-numbered signal turns off the switch 16.

In the tire information detecting apparatus according to this embodiment, when the odd-numbered signal is output from the contact type switch 21 of the ground detecting sensor provided in the tire, the switch 16 is turned off. Then, the pressure sensor 17 is disconnected from the crystal resonator 15. In this case, the controller measures the temperature of the tire on the basis of the resonant frequency signal transmitted from the transponder 10. Meanwhile, when the even-numbered signal is output from the contact type switch 21 of the ground detecting sensor provided in the tire, the switch 16 is turned on. Then, the pressure sensor 17 is connected to the crystal resonator 15. In this case, the controller measures the air pressure of the tire on the basis of the resonant frequency signal transmitted from the transponder 10.

In order to measure the temperature and air pressure of the tire, in the controller, the amplitude of an about 2.4 GHz carrier wave (f1) is modulated by an oscillation signal having a frequency (f2) that is generated by an oscillator G2, and the amplitude-modulated high-frequency signal is radiated from an antenna A1. Then, the amplitude modulation stops at a time t1, and a receiver E1 is activated at a time t2 (see FIG. 5). At the time when the amplitude modulation stops, a carrier wave whose amplitude is not modulated is radiated from the antenna A1.

In the transponder 10, the about 2.4 GHz high-frequency signal whose amplitude is modulated by the controller is detected by the diode 12, and the about 2.4 GHz carrier wave is removed by the low pass filter (the inductor 13 and the capacitor 14). In this way, a signal having the same frequency as the oscillation signal having the frequency (f2) is extracted. Since the resonant frequency of the crystal resonator 15 is closed to the frequency (f2) of the oscillation signal, the crystal resonator 15 is excited by the signal. In this way, the resonant frequency signal of the crystal resonator 15 is generated.

As described above, when the contact type switch 21 of the ground detecting sensor outputs an odd-numbered signal to turn off the switch 16, the pressure sensor 17 is disconnected from the crystal resonator 15. Therefore, the resonant frequency of the crystal resonator 15 is affected by only the temperature of the tire.

When the controller stops amplitude modulation and a carrier wave whose amplitude is not modulated is radiated, the crystal resonator 15 continues to resonate for about one millisecond or less after the amplitude modulation stops in the transponder 10. Therefore, the carrier wave from the controller whose amplitude is not modulated is amplitude-modulated by the diode 12 in response to the resonant frequency signal of the crystal resonator 15 and then radiated from the antenna 11. The receiver E1 of the controller receives the high-frequency signal whose amplitude is modulated through an antenna A4, and a demodulator (not shown) extracts the resonant frequency signal, thereby calculating the temperature of the tire.

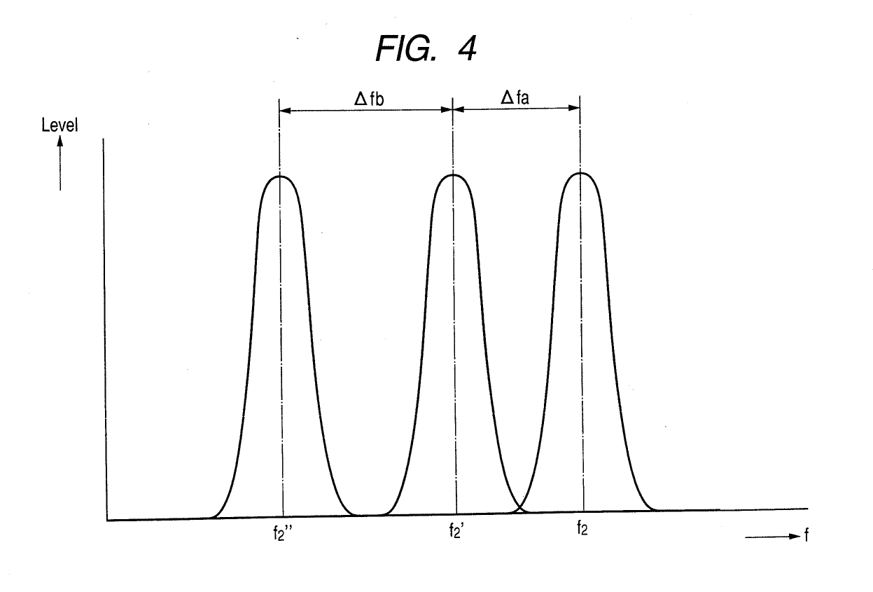

Next, a process of calculating the temperature of the tire will be described with reference to FIG. 4. In order to calculate the temperature of the tire, the receiver E1 determines the deviation (frequency difference) between the frequency (f2) of the oscillation signal generated by the oscillator G2 of the controller and a resonant frequency (f2′) extracted from the signal received by the transponder 10. That is, when the temperature of the tire varies, the resonant frequency of the crystal resonator 15 varies. Therefore, as shown in FIG. 4, it is possible to appropriately calculate the temperature of the tire using a single crystal resonator 15 by calculating the difference between the resonant frequency (f2′) and the frequency (f2) of the oscillation signal (Δfa in FIG. 4).

It is preferable to make a table indicating the relationship between the deviation between the resonant frequencies and a variation in the temperature of the tire beforehand and refer to the table, in order to calculate the temperature of the tire. The resonant frequency of the crystal resonator 15 varies according to the temperature. Therefore, when the difference between the frequency of the oscillation signal and the resonant frequency increases, the intensity of the received signal may be weakened. In this case, the frequency of the oscillation signal is decreased to perform the measurement again.

Meanwhile, when the contact type switch 21 of the ground detecting sensor outputs an even-numbered signal to turn on the switch 16, the pressure sensor 17 is connected to the crystal resonator 15. Therefore, the resonant frequency of the crystal resonator 15 is affected by the air pressure of the tire detected by the pressure sensor 17 as well as the temperature of the tire.

Similar to the process of measuring the temperature of the tire, when the controller stops amplitude modulation and a carrier wave whose amplitude is not modulated is radiated, the crystal resonator 15 continues to resonate for about one millisecond or less after the amplitude modulation stops in the transponder 10. Therefore, the carrier wave from the controller whose amplitude is not modulated is amplitude-modulated by the diode 12 in response to the resonant frequency signal of the crystal resonator 15 and then radiated from the antenna 11. The receiver E1 of the controller receives the high-frequency signal whose amplitude is modulated through the antenna A4, and a demodulator (not shown) extracts the resonant frequency signal, thereby calculating the air pressure of the tire.

Next, a process of calculating the air pressure of the tire will be described with reference to FIG. 4. In order to calculate the air pressure of the tire, the receiver E1 calculates the deviation (frequency difference) between the resonant frequency (f2″) that is extracted from the signal received by the transponder 10 when the temperature of the tire is calculated and a resonant frequency (f2″) that is extracted from the signal currently received by the transponder 10. That is, in the case in which the switch 16 is turned on and the pressure sensor 17 is connected to the crystal resonator 15, if the air pressure of the tire varies, the resonant frequency of the crystal resonator 15 varies. Therefore, as shown in FIG. 4, it is possible to appropriately calculate the air pressure of the tire using a single crystal resonator 15 by calculating the difference between the resonant frequency (f2″) and the resonant frequency (f2′) detected when the temperature of the tire is calculated (Δfb in FIG. 4).

In particular, the comparison between the resonant frequency (f2′) and the resonant frequency (f2″) makes it possible to remove a process of correcting measured values including the air pressure of the tire measured by a crystal resonator for measuring the air pressure of the tire on the basis of a value corresponding to the temperature of the tire measured by a crystal resonator for measuring the temperature of the tire, unlike the related art. Therefore, the measurement of the temperature and air pressure of the tire is not affected by the difference between the temperature characteristics of the crystal resonators or the difference between the degradation characteristics of the crystal resonators with time. As a result, it is possible to rapidly and accurately calculate both the temperature and the air pressure of the tire using a single crystal resonator 15.

Further, it is preferable to make a table indicating the relationship between the deviation between the resonant frequencies and a variation in the air pressure of the tire beforehand and refer to the table, in order to calculate the air pressure of the tire. The resonant frequency of the crystal resonator 15 depends on the temperature and the air pressure of the tire. Therefore, when the difference between the frequency of the oscillation signal and the resonant frequency increases, the intensity of the received signal may be weakened. In this case, the frequency of the oscillation signal is decreased to perform the measurement again.

However, in the tire information detecting apparatus according to this embodiment, the controller calculates measured values, such as the temperature and the air pressure of the tire, on the basis of the resonant frequency signal transmitted from the transponder 10. However, in this case, errors may occur in the controller during the calculating process. The errors occurring in the controller depend on the frequency of a signal to be measured. Therefore, in order to reduce the errors occurring in the controller, it is preferable to decrease the frequency of a signal to be measured.

In this case, in the tire information detecting apparatus according to this embodiment, the errors occurring in the controller depends on the difference in frequency between a resonant frequency signal corresponding to the off state of the switch 16 and a resonant frequency signal corresponding to the on state of the switch 16 (Δfb in FIG. 4). Therefore, it is possible to considerably reduce the errors occurring in the controller, as compared to the structure in which the errors occurring in the controller depends on a resonant frequency signal corresponding to the on state of the switch 16.

As described above, according to the tire information detecting apparatus of this embodiment, since the connection between the crystal resonator 15 (resonator) and the pressure sensor 17 is changed by the switch 16, it is possible to transmit resonant frequency signals corresponding to the temperature and air pressure of the tire using a single crystal resonator 15. As a result, the controller can calculate the temperature and air pressure of the tire on the basis of the difference between the resonant frequencies from the crystal resonator 15, thereby accurately detecting a plurality of measured values including the temperature and air pressure of the tire.

In particular, in the tire information detecting apparatus according to this embodiment, since the switch 16 is turned on or off according to the rotation of the tire to connect or disconnect the crystal resonator 15 (resonator) to or from the pressure sensor 17, it is possible to reliably connect or disconnect the crystal resonator 15 (resonator) to or from the pressure sensor 17 according to the traveling conditions of a vehicle.

Although the embodiment has been described above, the invention is not limited thereto. For example, various modifications and changes of the invention can be made without departing from the scope and spirit of the invention. The invention is not limited to the components shown in the accompanying drawings in the above-described embodiment, but various modifications of the components can be made within the scope of the invention. In addition, other components can also be appropriately changed without departing from the object of the invention.

For example, in the tire information detecting apparatus according to the above-described structure, the transponder 10 includes the crystal resonator 15, but the structure of the transponder 10 is not limited thereto. For example, the transponder 10 may include a ceramic resonator or a piezoelectric single crystal resonator formed of a piezoelectric single crystal, such as lithium tantalate (LiTaO₃), niobium tantalate (LiNbO₃), lithium borate (Li₂B₄O₇), potassium niobate (KNbO₃), langasite (La₃Ga₅SiO₁₄), langanite (La₃Nb_{0.5}Ga_{5.5}O₁₄), or langatate (La₃Ta_{0.5}Ga_{5.5}O₁₄). Among them, a resonator capable of stably resonating and ensuring high detection accuracy is used as the crystal resonator 15.

1. A tire information detecting apparatus comprising:
a measured value transmitter that is provided in a tire of a vehicle; and
a controller that is provided in a vehicle body and transmits/receives signals to/from the measured value transmitter,
wherein the measured value transmitter comprises:
an antenna;
a modem (modulator/demodulator) that modulates or demodulates the signals transmitted between the measured value transmitter and the controller;
a resonator that resonates in response to a signal transmitted from the controller;
a pressure sensor that detects the air pressure of the tire; and
a switch that connects or disconnects the resonator to or from the pressure sensor.

2. The tire information detecting apparatus according to claim 1,
wherein the switch is turned on or off according to the rotation of the tire to connect or disconnect the resonator to or from the pressure sensor.

3. The tire information detecting apparatus according to claim 2,
wherein the switch is turned on or off according to whether the connection of a specific point of the tire in a circumferential direction thereof to the ground is detected to connect or disconnect the resonator to or from the pressure sensor.

4. The tire information detecting apparatus according to claim 2,
wherein the switch is turned on or off according to the angle of the tire to connect or disconnect the resonator to or from the pressure sensor.

5. The tire information detecting apparatus according to claim 1,
wherein the controller transmits a signal for allowing the resonator to resonate to the measured value transmitter, and receives a resonant frequency signal of the resonator from the measured value transmitter, and
the controller calculates the temperature and air pressure of the tire on the basis of a resonant frequency of the resonator extracted from the received signal.

6. The tire information detecting apparatus according to claim 5,
wherein the controller calculates the air pressure of the tire on the basis of a difference between the resonant frequency extracted from the signal that is received from the measured value transmitter when the pressure sensor is disconnected from the resonator and the resonant frequency extracted from the signal that is received from the measured value transmitter when the pressure sensor is connected to the resonator.

7. The tire information detecting apparatus according to claim 5,
wherein the controller statistically processes the signal received from the measured value transmitter to calculate the temperature or the air pressure of the tire.

8. The tire information detecting apparatus according to claim 1,
wherein the resonator includes a crystal resonator.

9. A tire information detecting apparatus comprising:
a measured value transmitter that is provided in a tire of a vehicle; and
a controller that is provided in a vehicle body and transmits/receives signals to/from the measured value transmitter,
wherein the measured value transmitter comprises:
a resonator that resonates in response to a signal transmitted from the controller;
a pressure sensor that detects the air pressure of the tire; and
a switch that connects or disconnects the resonator to or from the pressure sensor,
wherein the switch is turned on or off according to the rotation of the tire to connect or disconnect the resonator to or from the pressure sensor.

10. The tire information detecting apparatus according to claim 9, wherein the measured value transmitter further comprises:
an antenna; and
a modem (modulator/demodulator) that modulates or demodulates the signals transmitted between the measured value transmitter and the controller.

11. The tire information detecting apparatus according to claim 9,
wherein the switch is turned on or off according to whether the connection of a specific point of the tire in a circumferential direction thereof to the ground is detected to connect or disconnect the resonator to or from the pressure sensor.

12. The tire information detecting apparatus according to claim 9,
wherein the switch is turned on or off according to the angle of the tire to connect or disconnect the resonator to or from the pressure sensor.

13. The tire information detecting apparatus according to claim 9,
wherein the controller transmits a signal for allowing the resonator to resonate to the measured value transmitter, and receives a resonant frequency signal of the resonator from the measured value transmitter, and
the controller calculates the temperature and air pressure of the tire on the basis of a resonant frequency of the resonator extracted from the received signal.

14. The tire information detecting apparatus according to claim 13,
wherein the controller calculates the air pressure of the tire on the basis of a difference between the resonant frequency extracted from the signal that is received from the measured value transmitter when the pressure sensor is disconnected from the resonator and the resonant frequency extracted from the signal that is received from the measured value transmitter when the pressure sensor is connected to the resonator.

15. The tire information detecting apparatus according to claim 14,
wherein the controller statistically processes the signal received from the measured value transmitter to calculate the temperature or the air pressure of the tire.

16. The tire information detecting apparatus according to claim 9,
wherein the resonator includes a crystal resonator.

17. A tire information detecting apparatus comprising:
a measured value transmitting means that is provided in a tire of a vehicle; and
a controlling means that is provided in a vehicle body and transmits/receives signals to/from the measured value transmitting means,
wherein the measured value transmitting means comprises:
a resonating means that resonates in response to a signal transmitted from the controlling means;
a pressure sensing means that detects the air pressure of the tire; and
a switching means that connects or disconnects the resonator to or from the pressure sensing means,
wherein the switching means is turned on or off according to the rotation of the tire to connect or disconnect the resonating means to or from the pressure sensing means.

18. The tire information detecting apparatus according to claim 17,
wherein the switching means is turned on or off according to whether the connection of a specific point of the tire in a circumferential direction thereof to the ground is detected to connect or disconnect the resonating means to or from the pressure sensing means.

19. The tire information detecting apparatus according to claim 17,
wherein the switching means is turned on or off according to the angle of the tire to connect or disconnect the resonating means to or from the pressure sensing means.

20. The tire information detecting apparatus according to claim 17,
wherein the controlling means transmits a signal for allowing the resonating means to resonate to the measured value transmitting means, and receives a resonant frequency signal of the resonating means from the measured value transmitting means, and
the controlling means calculates the temperature and air pressure of the tire on the basis of a resonant frequency of the resonating means extracted from the received signal.
